(19) United States
(12) Patent Application Publication
(10) Pub. No.: US 2011/0047093 A1
(43) Pub. Date: Feb. 24, 2011

(54) Closed-End Fund with Hedging Portfolio

(76) Inventor: Thomas E. Faust,, JR., Boston, MA (US)

Correspondence Address: Richard L. Sampson;SAMPSON & ASSOCIATES, P.C., 50 Congress Street, Boston, MA, 02109, US

(21) Appl. No.: 12/545,953

(22) Filed: Aug. 24, 2009

(51) Int. Cl. G06Q 40/00

(52) U.S. Cl. 705/36 R

(57) ABSTRACT

A computer implemented system and method for administering a closed-end-fund (CEF) includes configuring the CEF to have a plurality of units available for sale to the public, the units being configured for trading on one or more secondary markets, and the fund having a predetermined fund maturity date. A fund portfolio of assets are identified, which are liquidatable, substantially coincidentally with the fund maturity date, and that have a predetermined monetary value. The fund portfolio of assets is purchased and held within the fund. A hedge portfolio is identified, configured to substantially offset financial risk associated with the fund, and published.

### BACKGROUND

1. Technical Field

This invention relates to a system and method for investment and, more particularly, to an investment vehicle that buys and holds securities, derivatives and/or other investments in a closed-end fund structure with a fixed term and a publicized hedge portfolio to enable efficient trading of the fund's shares on a secondary market.

2. Background Information

Investment advisors have long recognized, and have advised their clients, that investments in stocks, bonds and other market-traded securities may be one of the best ways to accumulate wealth over the long term. However, direct investment in individual securities carries risks and rewards that may not match a particular investor's investment goals and risk tolerances. A wide variety of pooled investment vehicles have been developed to provide investors with convenient access to a range of strategies incorporating direct or indirect securities investments. Examples of such investment vehicles include open-end mutual funds, closed-end funds, unit investment trusts, exchange-traded funds, structured notes and exchange-traded notes.

Open-end mutual funds (“mutual funds”) issue shares representing fractional interests in the fund's underlying investment portfolio on a daily basis at a price based on the current net asset value per share (“NAV”) of the fund's assets. Mutual funds are typically offered on a continuous basis and are generally not subject to a fixed termination date. Mutual fund investors are entitled to redeem their interests in the fund at NAV on a daily basis. Mutual funds are subject to daily changes in the size of their portfolios depending on the net purchase and redemption activity of the fund's investors. Actively managed mutual funds are also subject to changes in the composition of their portfolios based on the actions of the investment advisor. Changes in the size and composition of a mutual funds' portfolio impose trading costs and may interfere with attaining its investment objectives.

Mutual funds offered for public sale in the United States must be registered as open-end investment companies under the Investment Company Act of 1940, as amended (the “1940 Act”). Among other limitations, the 1940 Act restricts a mutual fund's ability to invest in illiquid assets and to employ financial leverage.

Closed-end funds (“CEFs”) issue shares in an initial public offering and generally do not issue additional shares thereafter except in connection with reinvested distributions or through a rights offering or shelf registration. Liquidity to CEF shareholders is normally providing through secondary market trading on a securities exchange. Unlike mutual fund shares, CEF shares are generally not redeemable back to the issuing fund. Nearly all existing CEFs are actively managed and perpetual in nature. Compared to mutual funds, CEFs offer the advantage of a substantially fixed pool of assets that can be structured and managed without influence by shareholder inflows and outflows. In secondary market trading, CEF shares frequently trade at discounts to current NAV, reflecting the difficulties of effecting an arbitrage due to the funds' perpetual nature and limited holdings transparency. Like mutual funds, CEFs sold publicly in the U.S. must be registered under the 1940 Act. Because CEFs are not exposed to the need to meet shareholder redemptions, they are permitted under the 1940 Act to operate with greater leverage than mutual funds and, different from mutual funds, can invest without restriction in illiquid assets.

Unit investment trusts (“UITs”) are fixed-term vehicles that hold substantially fixed portfolios that are not subject to active management. Like mutual fund shareholders, investors in UITs may redeem their interests on a daily basis at a price based on current NAV. Like mutual funds (and different from CEFs), UITs are subject to portfolio shrinkage due to shareholder withdrawals. Like mutual funds and CEFs, UITs offered publicly in the U.S. must be registered under the 1940 Act. UITs are subject to similar limitations as mutual funds in regards to use of financial leverage and investment in illiquid assets.

Exchange-traded funds (“ETFs”) are a special type of mutual fund (or, less commonly, UIT) whose shares trade on a securities exchange. ETFs shares may be created or redeemed in unit basket amounts by broker-dealer firms serving as “authorized participants” in the ETF. For most ETFs, creation and redemption of units takes place primarily through the delivery of baskets of securities that closely replicate the current unit holdings of the ETF. The market trading price of ETF shares is generally within a close range of its NAV. If an ETF were to trade at significant discount (or premium) to its NAV, this would provide the ETF's authorized participants with the opportunity to earn an arbitrage profit by: (1) buying (selling) unit quantities of ETF shares in the market; (2) simultaneously selling (buying) unit quantities of the underlying securities that comprise the ETF's portfolio; and (3) redeeming (purchasing) that number of ETF units at that day's market close, with the redemption (purchase) effected in kind by the delivery of securities corresponding to the ETF's portfolio, equivalent to the securities that were sold (bought) in step #2 above. This arbitrage mechanism allows an ETF to respond to changes in market demand by shrinking or growing the amount of outstanding shares, while maintaining market trading prices near NAV levels.

ETFs that trade publicly in the U.S. are registered under the 1940 Act as mutual funds or UITs, and are subject to the same investment restrictions as non-ETF versions of those vehicles.

Structured notes are debt obligations of an issuer (frequently a financial institution) that include a contingent payout component tied to the performance of a specified benchmark or index. Structured notes provide a means for expressing an investment view that may not be readily available through other instruments, including strategies involving embedded options and leverage. Some structured notes pay interest, others do not. Structured notes have a fixed term, may be offered publicly or private, and may or may not be exchange listed. Even for exchange-listed structured notes, liquidity is often quite limited and dependent on the support of the issuer. Secondary trading, when it exists, is often at a discount to economic value. By their nature, structured notes involve a concentrated credit exposure to the issuer. Structured notes are not investment companies. As such, they are not subject to 1940 Act registration or the limitations imposed on 1940 Act-registrants.

Exchange-traded notes (“ETNs”) are publicly traded structured notes that employ mechanisms similar to those utilized by ETFs to limit secondary market premiums and discounts to NAV. Like ETFs, ETNs issue and redeem unit participations on a daily basis through authorized participants. Different from ETFs, ETNs are not investment companies registered under the 1940 Act and thus may engage in strategies and utilize instruments not available to 1940 Act-registered companies. Like other structured notes, ETNs involve a concentrated credit exposure to the issuer.

Although closed-end funds have existed for more than a century, pre-dating the other pooled vehicles described herein, their development and use to date has been comparatively limited. Total assets in CEFs have for many years lagged mutual fund assets by a wide margin, and now also trail investment in ETFs and structured notes.

Like structured notes, CEFs can provide a means for expressing market views and implementing strategies that are not available to investors in mutual funds, UITs and ETFs due to the 1940 Act-imposed and practical limitations on funds that issue daily redeemable securities. Currently, this investor need is being provided primarily through structured notes (including ETNs), for which the market has developed rapidly in recent years. But as investors in structured notes issued by Lehman Brothers were painfully made aware in 2008, these instruments involve a structural exposure to a concentrated credit risk in the sponsoring institution—a risk that can be avoided by using CEFs rather than structured notes.

The inventor believes the primary reason CEFs have not entered into more widespread use is the trading discounts that persistently apply to today's CEFs. A much broader role for CEFs in the armamentarium of investors is likely to develop if this issue can be effectively addressed.

### SUMMARY

In an aspect of the present invention, a computer implemented method of administering a closed-end-fund (CEF) includes configuring, electrically, the CEF to have a plurality of units available for sale to the public, the units being configured for trading on one or more secondary markets, and the fund having a predetermined fund maturity date. The method also includes identifying, electrically, a fund portfolio of assets being liquidatable, substantially coincidentally with the fund maturity date, and having a predetermined monetary value. The fund portfolio of assets is purchased and held within the fund. A hedge portfolio is identified, configured to substantially offset financial risk associated with the fund, and published.

In another aspect of the invention, a computer-implemented system for administering a closed-end-fund (CEF) includes a Closed-End Fund Module configured to, using a computer, define a CEF having a plurality of units available for sale to the public, the units being configured for trading on one or more secondary markets, and the fund having a predetermined fund maturity date. A Fund Portfolio ID Module is configured to identify a fund portfolio of assets being liquidatable substantially coincidentally with the fund maturity date, and having a predetermined monetary value. A Transaction Module is configured to direct the purchase and holding within the fund, the fund portfolio, and the derivatives. A Hedge Portfolio Module is configured to identify a hedge portfolio configured to substantially offset financial risk associated with the fund. A Publication Module is configured to publish the hedge portfolio.

In yet another aspect of the invention, an article of manufacture for administering a closed-end-fund (CEF) includes a computer usable medium having an executable computer readable program code embodied therein. The computer readable program code is configured for configuring the CEF to have a plurality of units available for sale to the public, and to have a predetermined fund maturity date. The program code is also configured for identifying an underlying asset portfolio of assets having desired performance characteristics, and identifying a fund portfolio of assets including cash-like instruments being liquidatable substantially coincidentally with the fund maturity date, and having a predetermined monetary value. The program code also configures a plurality of derivatives having predetermined derivative maturity dates substantially coinciding with the fund maturity date, the derivatives including financial derivatives linked to underlying assets including the underlying asset portfolio, and in which the monetary value of the underlying assets of the derivatives represents a predetermined percentage of said predetermined monetary value. Program code is further provided for effecting the purchase and holding within the fund the fund portfolio of assets, and purchasing and holding within the fund the derivatives. Program code is also configured for identifying a hedge portfolio configured to substantially offset financial risk associated with the fund, publish the hedge portfolio, the fund's NAV, and fund expenses, the value of the hedge portfolio, and the potential return an investor would have realized had the investor purchased the hedge portfolio along with the shares of the fund at a point in time. Moreover, program code is adapted for configuring the units for trading on one or more secondary markets.

### BRIEF DESCRIPTION OF THE DRAWINGS

The above and other features and advantages of this invention will be more readily apparent from a reading of the following detailed description of various aspects of the invention taken in conjunction with the accompanying drawings (“Figures”), in which:

FIG. 1 is a functional block diagram of a system embodying aspects of the present invention; and

FIG. 2 is a view similar to that of FIG. 1 of an optional embodiment of the present invention.

### DETAILED DESCRIPTION

In the following detailed description, reference is made to the accompanying Figures that form a part hereof and, in which is shown by way of illustration, specific embodiments in which the invention may be practiced. These embodiments are described in sufficient detail to enable those skilled in the art to practice the invention, and it is to be understood that other embodiments may be utilized. It also is to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying Figures are indicated with like reference numerals and similar features as shown in alternate embodiments in the Figures are indicated with similar reference numerals.

Briefly summarized, embodiments of the present invention facilitate the operation and management of a CEF in the form of a series trust having shares available for purchase by an investor, while providing for a fixed term investment combined with efficient trading of the shares on a secondary market through the publication of a hedging portfolio.

These embodiments enable investment in any number of assets of various types, ranging from relatively straight forward to relatively complex portfolios. While the CEF holds the assets and has a fixed term maturity, transparency and simplicity is provided by publishing a hedging portfolio configured to offset (i.e., neutralize) substantially all financial risk associated with the fund on a periodic (e.g., daily) basis. The actual holdings of the fund also may be published periodically along with the value of the hedge portfolio and the potential return an investor could receive if they had bought the fund's shares at a discount and invested in the hedge portfolio at the same time. Such publication is intended to generate efficient trading of the fund shares on secondary markets, such as the New York Stock Exchange (“NYSE”), by reducing or substantially eliminating any difference in price between the market value of the fund's shares and the fund's NAV.

Herein, the following terminology is used:

An “investor” is a person or business entity that opens an account for the purposes of investing in stocks, securities or other financial instruments.

The term “computer” is meant to encompass one or more workstation, personal computer, personal digital assistant (PDA), wireless telephone, or any other suitable computing device, which may be coupled to one another using links that may include one or more local area networks (LANs), metropolitan area networks (MANs), wide area networks (WANs), the Internet, or any other appropriate wireline, wireless, or other link. The components of embodiments of the present invention may operate on one or more computers at one or more locations, according to particular needs.

A “security” or “financial instrument” is any one of a number of interests, including common stock, preferred stock, bonds, notes, bills, options, puts, calls, futures, warrants, mutual fund shares, or any other type of interests typically issued or traded in units or as contracts, such as shares, derivatives or over-the-counter contracts (“OTC”).

An “issuer” is a company, partnership or other business or entity that issues securities or enters into contracts that can be purchased by investors.

Embodiments of the present invention may be implemented in one or more computers, in various hardware and operating environments known to those skilled in the art. These embodiments thus are not limited to any type of computer(s). Elements of the systems and methods embodying the present invention may be programmed in any suitable language and technology, such as Hypertext Markup Language (HTML); Active ServerPages (ASP); JavaScript C++; Visual Basic; Java; VBScript; Jscript; BCMAscript; and XML. Any suitable database technology can be employed, including, but not limited to: Microsoft Access and IBM AS 400.

An aspect of the invention was the realization that although the CEF structure may be used to conveniently hold a wide variety of asset types, shares of such funds often trade in the secondary market at discounts to the fund's NAV. In this regard, it was recognized that unlike open-end mutual funds, UITs, and ETFs, CEFs enjoy the convenience of not being required to allow for redemptions on a daily basis. A disadvantage associated with this convenience is that investors in CEFs who wish to sell their shares must generally sell their shares on the secondary market. Liquidation of such funds is a relatively infrequent occurrence, as CEFs typically have indeterminate terms. Moreover, the instant inventor has recognized that even in the event the assets held in a CEF were published more frequently than once per quarter, if those assets were complex, then their components may be difficult for investors to determine. Indeed, portfolios of conventional derivatives may be relatively complex, making them potentially difficult for many investors to fully understand and accurately replicate. The instant inventor also has recognized that these aspects may contribute to relatively large discounts relative to NAV, when CEF shares are traded on a secondary market, such as the NYSE.

Embodiments of the present invention seek to overcome the disadvantage of potentially large discounts relative to NAV, by providing both transparency and simplicity. This transparency and simplicity is provided by a CEF with a fixed term that periodically (e.g., daily) publishes its NAV and a hedge portfolio configured to substantially remove the financial risk of the fund's portfolio. In particular embodiments, the actual holdings of the fund also may be published periodically along with the value of the hedge portfolio and the potential return an investor could receive if they had bought the fund's shares at a discount and invested in the hedge portfolio at a particular point in time.

For example, a fund may hold a OTC derivative contract that replicates the purchase of a call spread (i.e., having purchased a call with a first strike price and sold a call with a second strike price) and a put sold with a third strike price that matures at approximately the end of the term of the fund. The fund may then publish a hedge portfolio that includes shorting the call spread (i.e., selling a call with the first strike price and purchasing a call with the second strike price) and purchasing a put at the third strike price with the same maturity date. The fund may also publish the value of the hedge portfolio along with the potential return an investor could receive if they had bought the fund's shares at a discount and transacted in the hedge portfolio at the same time.

Knowing the hedge portfolio and the value of the hedge portfolio, an arbitrageur effectively may neutralize the risk associated with the portfolio to maturity and trade the fund shares on a secondary market simply to take advantage of any discount in the value of the shares relative to the fund's NAV. This ability, provided by the periodic publication of the hedge portfolio, is expected to effectively reduce, if not substantially eliminate, any trading discount of the fund shares relative to the fund's NAV. It should also be recognized that this reduction or elimination of the trading spread is accomplished indirectly (i.e., without having to take any action within the fund itself, other than publishing the hedge portfolio and optionally the value of the hedge portfolio). In particular embodiments, this indirect approach helps to preserve benefits, such as tax efficiency/deferral, as discussed in greater detail hereinbelow.

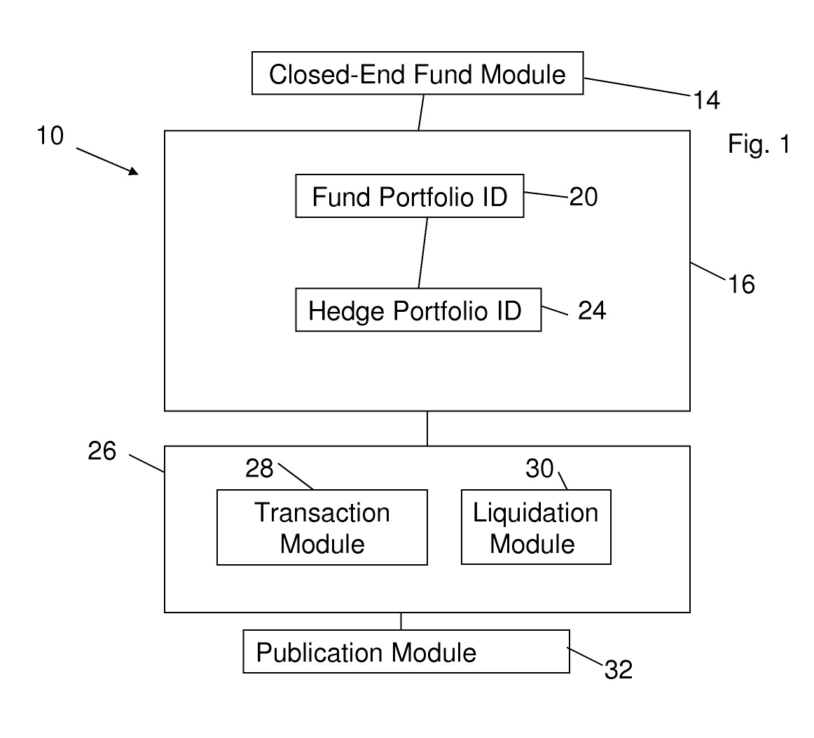

Turning now to the Figures, embodiments of the present invention will be described in detail. Referring now to FIG. 1, an Investment Fund System (“Fund System”) 10 of the present invention includes a Closed-End Fund Module 14 configured to define a CEF having a plurality of units available for sale to the public and, unlike many conventional CEFs, has a predetermined fund maturity date. Closed-End Fund Module 14 also may be configured to receive investments (purchases of fund units) by investors and to maintain records relating to the units. Fund System 10 also includes a Portfolio Module 16 having a Fund Portfolio Identification (“Fund Portfolio ID”) Module 20, and a Hedge Portfolio Identification (“Hedge Portfolio ID”) Module 24.

Module 20 is configured to identify a fund portfolio of assets having maturity or redemption dates, or which are otherwise redeemable or liquidatable, on dates that substantially coincide with the fund maturity date. Module 20 also may configure the identified assets to have a predetermined monetary value (e.g., associated with the monetary value of the fund units sold to investors). It is noted that Module 20 may identify assets of substantially any type (i.e., of substantially any type that are eligible for being held within CEFs in accordance with applicable law). Examples of such asset types include, but are not limited to, equity, debt, convertibles, warrants, U.S. Treasury securities (“U.S. Treasuries”), shares of money market funds or other mutual funds, OTC derivatives contracts, etc.

As also shown in FIG. 1, Fund System 10 includes a Hedge Portfolio ID Module 24 configured to identify a portfolio that an investor may purchase to effectively neutralize substantially all financial risk associated with the assets identified by Module 20. Module 24 may also provide the value of the Hedge portfolio and may also provide the return an investor could receive if they had invested in the fund shares and at the same time transacted in the Hedge Portfolio at a particular point in time. A Transaction System 26 may be provided, which includes a Transaction Module 28 and a Liquidation Module 30. Once the fund portfolio has been identified, Module 28 may be actuated to direct, and/or to automatically effect, the purchase (and/or sale, such as of various derivatives contracts) of those securities (e.g., assets) of the fund portfolio. Records pertaining to these purchased (or sold) securities may then be maintained by Closed-End Fund Module 14.

Liquidation Module 30 may be actuated to direct, and/or to automatically effect, the liquidation of fund assets, including the securities of the fund portfolio, at the maturity or liquidation dates of the fund assets as described hereinabove. Liquidation Module 30 may then be actuated in combination with Closed-End Fund Module 14 to liquidate the individual units held by investors. As also shown, a Publication Module 32 is configured to publish the hedge portfolio (and, optionally, the fund portfolio along with the value of the hedge portfolio and the potential return an investor could receive if they had bought the fund's shares at a discount and invested in the hedge portfolio at the same time) on a periodic basis, as mentioned above.

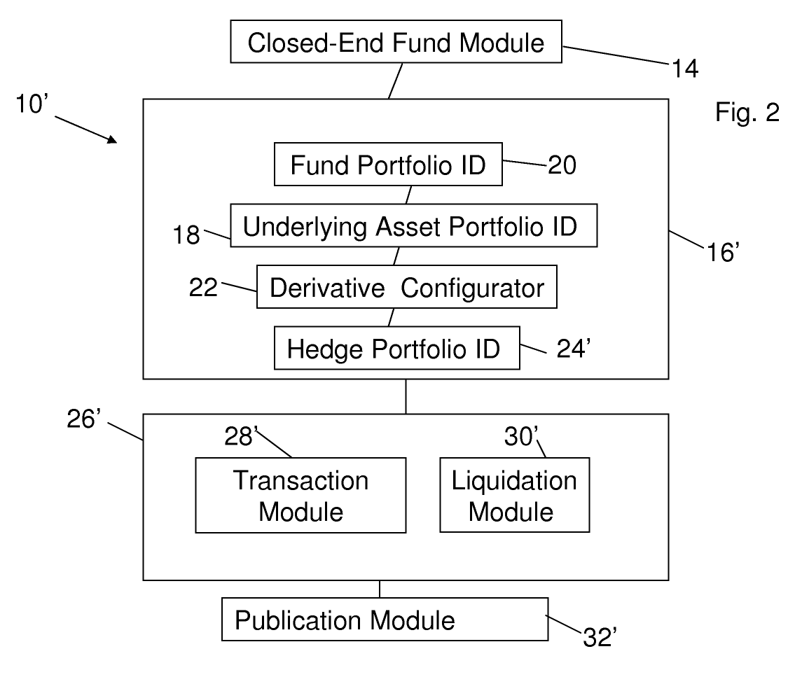

Turning now to FIG. 2, an alternative embodiment of the present invention is shown as Fund System 10′. This Fund System 10′ is substantially similar to Fund System 10, but for the following distinctions. As shown, Fund System 10′ includes a Portfolio Module 16′, which, in addition to Modules 20 and 24′, includes an optional Derivative Portfolio Configurator (“Derivative Configurator”) 22 and an Underlying Asset Portfolio Identification (“Underlying Asset Portfolio ID”) Module 18.

Underlying Asset Portfolio ID Module 18 is configured to identify an index or other group of securities representing an underlying asset portfolio of assets having desired performance characteristics, upon which various derivatives may be based. In particular embodiments, these underlying assets may include cash-like instruments such as U.S. Treasuries, shares of money market funds, and the like.

Derivative Configurator Module 22 operates in conjunction with Modules 18 and 20. Module 22 configures a series of derivatives linked to the underlying asset portfolio identified by Module 18 as their underlying assets. These derivatives also are configured to have a monetary value corresponding to a predetermined percentage of the monetary value of the fund portfolio identified by Module 20. In particular embodiments, these derivatives also are configured to have predetermined derivative maturity dates that substantially coincide with the fund maturity date.

It should be noted that such derivatives may be structured to reference underlying assets as identified by Module 18, without the fund necessarily holding these underlying assets. Rather, the fund may be invested primarily in other assets, which, as identified by Module 20, may include U.S. Treasuries (or other short term cash-like securities). This approach enables the fund, for example, to benefit from the safety of cash, and avoid risks associated with underlying assets, such as equities, etc., while also enabling the investor to participate in growth of those underlying assets through the structure of the derivatives. This approach also may contribute to tax efficiency/deferral (as discussed hereinbelow) since, unlike the underlying assets, U.S. Treasuries and other cash-like securities (and possibly indices that reinvest income) are unlikely to generate dividends that would significantly exceed the fund's expenses and that would need to be passed through to the investors. In addition, embodiments of the present invention may help minimize counterparty risk by configuring Transaction Modules 28, 28′ to distribute the derivative contracts (e.g., put and/or call contracts) among multiple counterparties and require the frequent posting of collateral by such counterparties, as will be described in greater detail hereinbelow.

Hedge Portfolio ID Module 24′ is configured to identify a portfolio that an investor may purchase to effectively neutralize substantially all financial risk associated with both the fund portfolio identified by Module 20 and the derivatives configured by Module 22. Module 24 may also provide the value of the Hedge portfolio and may also provide the return an investor could receive if they had invested in the fund shares and at the same time purchased the Hedge Portfolio at a particular point in time. Fund System 10′ also includes a Transaction System 26′, which may include a Transaction Module 28′ and a Liquidation Module 30′. Once the fund portfolio and underlying asset portfolio have been identified, and the derivatives configured, Transaction Module 28′ may be actuated to direct, and/or to automatically effect, the purchase (and/or sale) of securities (e.g., assets) of the fund portfolio and the derivatives. Records of these purchased securities may then be maintained by Closed-End Fund Module 14.

Liquidation Module 30′ may be actuated to direct, and/or to automatically effect, the liquidation of fund assets, including the derivatives (e.g., identified by Module 22) and the securities of the fund portfolio (e.g., identified by Module 20), at the maturity date or liquidation date of these fund assets. As mentioned above, in particular embodiments, the maturity/liquidation dates of these fund assets are predetermined to substantially coincide with the fund maturity date. Moreover, in particular embodiments, the liquidation and/or derivative maturity dates are deemed to substantially coincide with the fund maturity date as long as they precede the fund maturity date by about 30 to 90 days or less. Liquidation Module 30′ may then be actuated in combination with Closed-End Fund Module 14 to liquidate the individual units held by investors.

Publication Module 32′ is configured to publish the hedge portfolio on a periodic basis. Moreover, in particular embodiments, in addition to publishing the hedge portfolio, Publication Module 32′ may be configured to publish the identity of the fund portfolio and of the derivatives identified/configured by Modules 20 and 22, along with the value of the hedge portfolio and the potential return an investor could receive if they had bought the fund's shares at a discount and invested in the hedge portfolio at the same time. Modules 32, 32′ may further be configured to effect such publishing on a periodic basis, such as at predetermined intervals ranging from at least once per day, up to and including once per month.

In particular embodiments, the fund maturity date is configured to correspond to a holding period of the fund portfolio and the derivatives of at least one year and up to five years (or more). Moreover, the derivatives may take the form of “single contracts” (discussed hereinbelow), in which gain or loss therefrom is expected to qualify as long term capital gain/loss under U.S. Federal income tax laws. To further enhance tax efficiency, in various embodiments, the fund portfolio is configured to provide little, if any, current income. In particular, the fund portfolio may be configured so that any income generated thereby is less than or equal to the deductible operating expenses of the fund. This approach provides tax efficiency/tax deferral by helping to ensure that in various embodiments there is little or no income to pass through to investors prior to the fund maturity date.

As mentioned hereinabove, further tax advantages may be provided by structuring the derivatives as “single contracts” (i.e., in the form of one or more single OTC derivatives contracts, each having a counterparty). In a particular example, one such “single contract” may combine all three of the aforementioned components (i.e., a sold call contract, a purchased call contract, and a sold put contract). As long as these single contracts have a term (maturity) of 12 months or greater, any gain or loss thereon should be treated as long term, under current U.S. Federal tax laws. Further, derivatives are generally cash-settled, which enables the writer to simply pay cash to the extent the underlying asset (e.g., index) exceeds the exercise price on the contract valuation date. This aspect tends to reduce transaction costs, such as brokerage commissions, which otherwise may become significant in the event many such contracts are written.

Embodiments of Fund Systems 10 and 10′ thus facilitate taking long positions in relatively safe and liquid assets (e.g., cash or cash-like instruments) of one portfolio, while purchasing derivatives linked to another portfolio, all within a CEF. This CEF also is configured to provide substantial transparency and simplicity, including the daily disclosure of the fund's NAV and expenses of the fund, so that shares issued by the fund may be conveniently traded at relatively little premium or discount to the fund's NAV.

Moreover, by holding assets in a CEF, embodiments of Fund Systems 10 and 10′ are particularly well suited for a buy and hold strategy, as the portfolio typically cannot change during the term (i.e., until maturity). This approach also offers substantial advantages relative to other investment vehicles, such as ETFs. For example, the CEF of the instant invention may remain leveraged with derivatives on a buy and hold basis from initiation to the fund's liquidation. Unlike leveraged ETFs, the CEF does not have to contend with ongoing purchases and redemptions and the releveraging and deleveraging required by such actions. The lack of such daily leveraging tends to benefit investors seeking a longer-term leveraged investment with a fixed term while attempting to reduce discounts and premiums to NAV, as provided by the present embodiment.

The following illustrative examples demonstrate certain aspects and embodiments of the present invention and are not intended to limit the present invention to any one particular embodiment or set of features.

### Examples

### Example 1

As a non-limiting example of a particular embodiment, Fund System 10 configures a CEF to have a series of units available for sale to the public, the units being configured for trading on one or more secondary markets, and the fund having a predetermined fund maturity date. System 10 prescribes the purchase of a portfolio of assets, which may include any number and type of assets ranging from, for example, U.S. Treasuries to OTC derivatives contracts, with maturities approximating the fund maturity date and enters into collateral agreements with counterparties that require them to post collateral during the term of the contract in order to reduce counterparty credit risk. Fund System 10 then determines and publishes a hedge portfolio configured to neutralize the risk of the portfolio, and publishes the hedge portfolio on e.g., at least a daily basis. Fund System 10 may also provide the value of the hedge portfolio and may provide the return an investor could receive if they had invested in the fund shares and at the same time purchased the Hedge Portfolio at a particular point in time. This publication of the hedge portfolio and related information along with the fund's NAV effectively provides transparency into the fund's portfolio of assets to give investors the information necessary to arbitrage the market discount of the fund and as a result substantially reduce or eliminate any trading discount/premium of the fund shares relative to the fund's NAV. Such publication may be particularly useful, for example, in the event the portfolio includes a relatively complex combination of derivatives contracts whose components may not be evident from the disclosure of the fund's holdings. The fund then liquidates the portfolio for cash and distributes such cash to fund investors at the fund's maturity date.

In an extension of this Example 1, the Fund System 10 identifies an underlying asset portfolio, such as an index, and prescribes the purchase and potential value of derivatives based on this underlying asset portfolio.

### Example 2

As another non-limiting example of a particular embodiment, Fund System 10′ configures a CEF to have a series of units available for sale to the public, the units being configured for trading on one or more secondary markets, and the fund having a predetermined fund maturity date. Fund System 10′ prescribes the purchase of an asset portfolio, including U.S. Treasuries with maturities approximating the maturity of the fund. Fund System 10′ then identifies an underlying asset portfolio, such as the S&P 500® Index (“SPX”), and prescribes the purchase of OTC derivatives contracts linked to the SPX in accordance with the parameters of participating in N times (e.g., twice (2x)) the gains in the SPX of up to ten percent, while protecting capital from losses of up to ten percent. This is accomplished, for example, by prescribing in a single OTC derivatives contract, the: sale of one European-style put contract on the SPX and prescribing, with the proceeds of such sale, the purchase of N (e.g., two) “call spreads,” each of which has the economic effect of purchasing a European-style call contract on the SPX and simultaneously selling a European-style call contract on the SPX. In particular embodiments, the strike prices of the puts and calls in the OTC derivatives contract are configured so that the price received from the sale of the put contract substantially equals the price paid for the purchase of the call spreads. European-style put and call contracts are contracts that can be exercised only on their expiration dates rather than at any time during their term. These transactions are configured to have maturities that substantially coincide with the maturity of the CEF. These transactions also are combined and purchased as one or more single OTC derivatives contract, with maturity dates of one year or more from the date of purchase, so that any realized gain or loss from these contracts should be treated as long term under current U.S. Federal income tax laws. The fund determines and publishes the fund's NAV and a hedge portfolio and optionally the value of the hedge portfolio configured to neutralize the risk of the derivative contracts. The fund upon maturity then liquidates the assets for cash and distributes such cash to fund investors.

### Example 3

As a more specific example, the call spread contract of Example 2 is structured so that the purchased call contract is linked to the SPX with a strike price “at the money” (i.e., with today's index price). Then, if the SPX rises by the settlement date, the counterparty must settle at the percent increase of the SPX times the number (and monetary value) of contracts purchased. The number and value of contracts purchased may be configured to correspond to a predetermined percentage of the value of the fund portfolio identified by Module 20. For example, if the fund portfolio had a value of $1M, and Fund System 10 was configured to direct the purchase of calls at 300 percent (i.e., N=3) of the value of the fund portfolio, then the system directs the purchase of calls on $3M worth of assets. Such an approach thus generates (before costs/fees) 3× the gain of the underlying index up to a capped percent, such as 10 percent, as discussed below.

To help fund the cost of the purchased call contracts, the fund may sell, or write, cash-settled index call contracts slightly “out of the money” (i.e., with their exercise prices slightly above the current level of the index at the time the contracts are written). (In this example, the call contracts are “out of the money” by ten percent, in accordance with the parameters mentioned above.) The skilled artisan will recognize that, with other factors being equal, the premiums received for the call contracts tend to decrease as the exercise price is moved further out of the money, due to the associated decrease in risk that the contracts will be exercised. Accordingly, the writer may choose the exercise price of the call contracts, based upon a desired balance of premium and risk.

The Fund System 10 thus will have purchased calls at the money, and sold calls out of the money. In this example, if the SPX rises a percentage of up to ten percent, then the fund would exercise the purchased call contracts and the counterparty would pay the fund an amount based on the percentage increase times the number of calls purchased times the dollar value of each call. It will be understood, however, that if the market rises beyond ten percent, then the call contracts sold by the fund will be exercised by the counterparty, requiring the fund to effectively “sell” and, thus not participate in, any upside beyond ten percent.

In this scenario, the fund used the premiums received from the calls it sold (out of the money) to help pay for the calls it purchased (in the money). However, as discussed above, since the premiums received by the fund for the out of the money calls typically will be insufficient to completely cover the cost of the purchased calls, it may be desirable to raise additional capital. One way the fund may do so is by selling puts having strike prices a predetermined percentage below the current index value (e.g., ten percent below per the exemplary parameters mentioned above). Thus, in return for premium income, the fund takes the risk of having to pay for any losses in the index greater than ten percent. In this regard, the fund would potentially pay out an amount based on the percentage drop of the index (at maturity/settlement date) below negative ten percent times the dollar value of all put contracts sold.

The combined effect of the purchased call contracts, the sold call contracts, and the sold put contracts, would be to provide the fund with the opportunity to participate in gains of the index of up to ten percent (times N), while also protecting it against losses of the index of up to ten percent.

As mentioned hereinabove, the foregoing contracts may be combined and purchased as one or more single OTC derivatives contracts (derivatives), with maturity dates of one year or more from the date of purchase (typically, one to five years or more) in which collateral agreements are entered into with the counterparty which require the counterparty to post collateral during the life of the contract to seek to reduce counterparty credit risk. This is intended to ensure that, unlike the treatment of individual contracts, any realized gain or loss from these contracts should be treated as long term under current U.S. Federal income tax laws.

Still further, in particular embodiments of the present invention, the underlying asset portfolio (identified by Module 18), may be represented by a conventional stock index, such as the SPX. It should be recognized, however, that substantially any securities index may be used. While this list is not exhaustive, some other representative indices include the FTSE 100 Index, the Dow Jones EURO STOXX 50 Index and the Nikkei 225 Stock Average. Derivative Configurator Module 22 may then direct the purchase of derivatives.

Moreover, although index-based derivatives may be desired for many embodiments of Fund Systems 10 and 10′, these may be supplemented with other derivatives written on individual stocks within or outside of the underlying asset portfolio.

Having described various embodiments of the present invention, representative operation thereof will be described in conjunction with Table I.

TABLE I

| | |
|---|---|
| 40 | Define CEF having a predetermined fund maturity date, with |
| | units configured for distribution to investors and for |
| | trading on one or more secondary markets |
| 42 | Optionally, receive and record investments in the fund |
| 46 | Identify a fund portfolio of assets having redemption |
| | dates that substantially coincide with the fund maturity |
| | date, and that have a predetermined monetary value |
| 51 | Identify a hedge portfolio to neutralize risk associated |
| | with the assets held by the fund |
| 52 | Publish the hedge portfolio, value of the hedge portfolio, |
| | fund NAV, and potential return to a investor seeking to |
| | purchase the hedge portfolio, on a periodic basis |
| 54 | Purchase and/or sale of securities of the fund portfolio |
| 55 | Hold purchased securities |
| 56 | Liquidate fund assets |
| 58 | Liquidate individual units held by investors |

As shown, Closed-End Fund Module 14 is used to define 40, a CEF having a predetermined fund maturity date, including a plurality of units available for sale to the public, and for configuring the units for trading on one or more secondary markets. Module 14 may also optionally receive and record 42, investments in the fund. Fund Portfolio ID Module 20 identifies 46, a fund portfolio of assets having redemption dates that substantially coincide with the fund maturity date and that have a predetermined monetary value (e.g., associated with the monetary value of the fund units sold to investors). Hedge Portfolio ID Module 24 identifies 51, a hedge portfolio to effectively neutralize substantially all financial risk associated with the assets held by the fund. Publication Module 32 publishes 52, the hedge portfolio and the value of that hedge portfolio on a periodic basis.

Transaction Module 28 directs and/or automatically effects 54, the purchase and/or sale of securities of the fund portfolio of assets. The purchased securities are held 55, by Closed-End Fund Module 14. Liquidation Module 30 directs and/or automatically effects 56, the redemption/liquidation of fund assets at the maturity date of these fund assets. Liquidation Module 30, in combination with Closed-End Fund Module 14, may liquidate 58, the individual units held by investors.

In an alternate embodiment, the foregoing embodiment shown and described with respect to Table I, includes the aspects shown and described below with respect to Table II.

TABLE II

| | |
|---|---|
| 44 | Identify an index or other group of securities |
| | representing an underlying asset portfolio |
| 46′ | Identify a fund portfolio of assets, including cash-like |
| | instruments having redemption dates that substantially |
| | coincide with the fund maturity date and that have a |
| | predetermined monetary value |
| 48 | Configure a series of derivatives linked to the underlying |
| | asset portfolio as their underlying assets and that |
| | represent a predetermined percentage of the monetary value |
| | of the fund portfolio |
| 50 | Configure the derivatives to have derivative maturity |
| | dates that substantially coincide with the fund maturity |
| | date |
| 54′ | Purchase securities of the fund portfolio and purchase a |
| | sufficient volume of the derivatives so that the monetary |
| | value thereof corresponds to a predetermined percentage of |
| | the monetary value of the fund portfolio |

As shown, an Underlying Asset Portfolio ID Module 18 identifies 44, an index or other group of securities representing an underlying asset portfolio of assets having desired performance characteristics. At 46′, a fund portfolio of assets is identified to include cash-like instruments having redemption dates that substantially coincide with the fund maturity date and that have a predetermined monetary value. A Derivative Configurator Module 22, in conjunction with Modules 18 and 20, configures 48, a series of derivatives linked to underlying assets, including the underlying asset portfolio, and in which the monetary value of the underlying assets of the derivatives represents a predetermined percentage of the monetary value of the underlying asset portfolio. Derivative Configurator Module 22 also configures 50, the derivatives to have predetermined derivative maturity dates that substantially coincide with the fund maturity date. Transaction Module 28 directs and/or automatically effects 54′, the purchase of the derivatives as well as securities of the fund portfolio of assets.

Although exemplary embodiments of the subject invention have been shown and described with particular modules or components, those skilled in the art should recognize that one or more of these exemplary modules and/or functions performed thereby may be performed and/or supplied to these embodiments by third parties or otherwise related or unrelated separate entities, without departing from the spirit and scope of the present invention.

Moreover, although embodiments of the present invention have been shown and described with respect to the writing of call contracts primarily out of the money, such contracts may also be written in the money, without departing from the spirit and scope of the present invention.

It should be further noted that the various contracts described hereinabove may be purchased and written through any convenient market, such as the Option Clearing House (“OCC”), and/or OTC markets. It should be recognized, in light of the instant disclosure, that the use of OTC contracts tends to simplify collateral requirements by avoiding relatively strict OCC collateral rules.

It should also be recognized that Fund Portfolio ID Module 20 and/or Derivative Configurator Module 22 may configure portfolios and/or derivatives of substantially any type for substantially any investment strategy, including substantially any desired combination of market view and risk tolerance, without departing from the scope of the present invention.

In the preceding specification, the invention has been described with reference to specific exemplary embodiments thereof. It will be evident that various modifications and changes may be made thereunto without departing from the broader spirit and scope of the invention as set forth in the claims that follow. The specification and Figures are accordingly to be regarded in an illustrative rather than restrictive sense. It should also be recognized that aspects described with respect to any one of the embodiments hereof may be used with any of the other embodiments hereof, without departing from the spirit and scope of the present invention.

Having thus described the invention, what is claimed is:

1. A computer implemented method of administering a closed-end-fund (CEF), the method comprising:
(a) Configuring, electrically, the CEF to have a plurality of units available for sale to the public, the units being configured for trading on one or more secondary markets, and the fund having a predetermined fund maturity date;
(b) Identifying, electrically, a fund portfolio of assets being liquidatable, substantially coincidentally with the fund maturity date, and having a predetermined monetary value;
(c) Purchasing and holding within the fund the fund portfolio of assets;
(d) Identifying, electrically, a hedge portfolio configured to substantially offset financial risk associated with the fund; and
(e) Publishing, electrically, the hedge portfolio.

2. The method of claim 1, further comprising:
(f) Identifying, electrically, an underlying asset portfolio of assets having desired performance characteristics;
(g) Configuring, electrically, a plurality of derivatives having predetermined derivative maturity dates substantially coinciding with the fund maturity date, the derivatives linked to underlying assets, including the underlying asset portfolio, and in which the monetary value of the underlying assets of the derivatives represents a predetermined percentage of said predetermined monetary value; and
(h) Purchasing and holding within the fund the derivatives.

3. The method of claim 2, comprising publishing, electrically, the value of the hedge portfolio, the fund's net asset value and fund expenses.

4. The method of claim 3, comprising publishing, electrically, the potential return an investor would have realized had the investor purchased the hedge portfolio along with the shares of the fund at a point in time.

5. The method of claim 2, wherein the fund portfolio of assets is configured to include cash-like instruments.

6. The method of claim 5, further comprising publishing, electrically, the configuration of the plurality of derivatives.

7. The method of claim 6, further comprising publishing, electrically, the identity of the fund portfolio.

8. The method of claim 7, further comprising effecting said publishing at predetermined intervals of:
at least once per day; and
up to and including once per month.

9. The method of claim 1, comprising configuring the fund portfolio of assets to be liquidatable within 90 days prior to the fund maturity date.

10. The method of claim 9, comprising configuring the fund portfolio of assets to be liquidatable within 30 days prior to the fund maturity date.

11. The method of claim 1, comprising configuring the maturity date to correspond to a holding period of at least one year from the date of said purchasing (f).

12. The method of claim 11, comprising configuring the maturity date to correspond to a holding period of up to five years from the date of said purchasing (f).

13. The method of claim 2, wherein said configuring (g) comprises configuring the plurality of derivatives to qualify for long term capital gain/loss under U.S. Federal income tax laws.

14. The method of claim 13, wherein said configuring (g) further comprises configuring the derivatives in the form of single contracts, including single over-the-counter (OTC) derivatives contracts having a counterparty.

15. The method of claim 13, wherein said identifying (b) comprises identifying assets configured to generate income that is less than or equal to the expenses of operating the CEF.

16. The method of claim 1, comprising liquidating the fund assets and the fund units substantially at the fund maturity date.

17. A computer-implemented system for administering a closed-end-fund (CEF), the system comprising:
a Closed-End Fund Module configured to, using a computer, define a CEF having a plurality of units available for sale to the public, the units being configured for trading on one or more secondary markets, and the fund having a predetermined fund maturity date;
a Fund Portfolio ID Module configured to, using a computer, identify a fund portfolio of assets being liquidatable substantially coincidentally with the fund maturity date, and having a predetermined monetary value;
a Transaction Module configured to, using a computer, direct the purchase and holding within the fund, the fund portfolio, and the derivatives;
a Hedge Portfolio Module configured to, using a computer, identify a hedge portfolio configured to substantially offset financial risk associated with the fund;
a Publication Module configured to, using a computer, publish the hedge portfolio.

18. The system of claim 17, wherein the Publication Module is configured to, using a computer, publish the value of the hedge portfolio, the fund's net asset value and fund expenses.

19. The system of claim 18, wherein the Publication Module is configured to, using a computer, publish the potential return an investor would have realized had the investor purchased the hedge portfolio along with the shares of the fund at a point in time.

20. The system of claim 17, further comprising:
an Underlying Asset Portfolio ID Module configured to, using a computer, identify an underlying asset portfolio of assets having desired characteristics;
a Derivative Configurator Module configured to, using a computer, configure a plurality of derivatives having predetermined derivative maturity dates substantially coinciding with the fund maturity date, the derivatives including financial derivatives linked to underlying assets, including the underlying asset portfolio, and in which the monetary value of the underlying assets of the derivatives represents a predetermined percentage of said predetermined monetary value; and
wherein the Transaction Module is configured to purchase and hold within the fund the derivatives.

21. The system of claim 20, wherein the Fund Portfolio ID Module is configured to identify a fund portfolio of assets, including cash-like instruments.

22. The system of claim 20, wherein the Publication Module is configured to publish, electrically, the configuration of the plurality of derivatives.

23. The system of method of claim 22, wherein the Publication Module is configured to publish, electrically, the identity of the fund portfolio and the fund's NAV.

24. The system of claim 23, wherein the Publication Module is configured to effect the publishing, electrically, at predetermined intervals of:
at least once per day; and
up to and including once per month.

25. The system of claim 17, wherein the Fund Portfolio ID Module is configured to identify a fund portfolio of assets which are liquidatable within 90 days prior to the fund maturity date.

26. The system of claim 25, wherein the Fund Portfolio ID Module is configured to identify a fund portfolio of assets which are liquidatable within 30 days prior to the fund maturity date.

27. The system of claim 17, wherein the Closed-End Fund Module is configured to configure the maturity date to correspond to a holding period of at least one year from the date said fund portfolio is purchased.

28. The system of claim 27, wherein the Closed-End Fund Module is configured to configure the maturity date to correspond to a holding period of up to five years from the date said fund portfolio is purchased.

29. The system of claim 20, wherein the Derivative Configurator Module is configured to configure the plurality of derivatives to qualify for long term capital gain/loss treatment under U.S. Federal income tax laws.

30. The system of claim 29, wherein the Derivative Configurator Module is configured to configure the derivatives in the form of single contracts, including single OTC derivatives contracts having a counterparty.

31. The system of claim 30, wherein said Fund Portfolio ID Module is configured to identify assets configured to generate income that is substantially equal to or less than expenses of operating the CEF.

32. The system of claim 31, comprising a Liquidation Module configured to liquidate the fund assets and the fund units substantially at the fund maturity date.

33. An article of manufacture for administering a closed-end-fund (CEF), said article of manufacture comprising a computer usable medium having an executable computer readable program code embodied therein, said computer readable program code configured for:
Configuring the CEF to have a plurality of units available for sale to the public, and to have a predetermined fund maturity date;
Identifying an underlying asset portfolio of assets having desired performance characteristics;
Identifying a fund portfolio of assets including cash-like instruments being liquidatable substantially coincidentally with the fund maturity date, and having a predetermined monetary value;
Configuring a plurality of derivatives having predetermined derivative maturity dates substantially coinciding with the fund maturity date, the derivatives including financial derivatives linked to underlying assets including the underlying asset portfolio, and in which the monetary value of the underlying assets of the derivatives represents a predetermined percentage of said predetermined monetary value;
Purchasing and holding within the fund the fund portfolio of assets;
Purchasing and holding within the fund the derivatives;
Identifying a hedge portfolio configured to substantially offset financial risk associated with the fund; Publishing the hedge portfolio, the fund's NAV, and fund expenses;
Publishing the value of the hedge portfolio;
Publishing the potential return an investor would have realized had the investor purchased the hedge portfolio along with the shares of the fund at a point in time, and
Configuring the units for trading on one or more secondary markets.
